(19) United States
(12) Patent Application Publication
(10) Pub. No.: US 2026/0134292 A1
(43) Pub. Date: May 14, 2026

(54) SELECTIVE ADAPTATION OF PRE-TRAINED NEURAL NETWORK MODELS

(71) Applicant: GM Cruise Holdings, LLC, San Francisco, CA (US)

(72) Inventors: Reza Akbarian Bafghi, Boulder, CO (US); Carden Bagwell, San Francisco, CA (US); Avinash Aghoram Ravichandran, Seattle, WA (US)

(73) Assignee: GM Cruise Holdings, LLC, San Francisco, CA (US)

(21) Appl. No.: 19/328,050

(22) Filed: Sep. 12, 2025

Related U.S. Application Data
(60) Provisional application No. 63/720,110, filed on Nov. 13, 2024.

(51) Int. Cl. G06N 3/0985; B60W 50/00; B60W 50/04; B60W 50/06

(52) U.S. Cl. CPC G06N 3/0985; B60W 50/045; B60W 50/06; B60W 2050/0012; B60W 2050/0025; B60W 2050/0031; B60W 2050/0088

(57) ABSTRACT

A method adapts a pre-trained neural network model having layers with pre-trained weight matrices. At least one layer is augmented with a plurality of parameter-efficient adaptation modules, each module associated with a respective learnable scoring parameter. The model is fine-tuned on a target dataset while the pre-trained weight matrices are maintained in a frozen state. The fine-tuning includes performing a forward pass where an indicator function selectively applies a weight update from each module based on its scoring parameter and a threshold. A total loss value is determined from a task-specific loss and a sparsity-inducing regularization term. Parameters of the adaptation modules and the scoring parameters are updated based on the total loss value. A final, fine-tuned model having a sparse subset of activated adaptation modules is provided for an inference task.

### CROSS-REFERENCE TO RELATED APPLICATION

This application claims priority under 35 U.S.C. § 119(e) to U.S. Provisional Application Ser. No. 63/720,110, filed Nov. 13, 2024. The disclosure of this prior application is considered part of the disclosure of this application and is hereby incorporated by reference in its entirety.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to machine learning, and more specifically to systems and methods for adapting pre-trained neural network models to new tasks or domains.

Large-scale, pre-trained neural network models, such as vision models and vision-language models, are often trained on extensive datasets and are renowned for their ability to generalize across a wide variety of applications. To apply these general-purpose models to a more specialized task, such as recognizing objects in a particular environment or classifying domain-specific images, a process of adaptation or fine-tuning is typically performed. This adaptation aims to improve the model's performance on the new, specialized dataset.

One approach to adaptation is full fine-tuning, which involves retraining a substantial portion or all of the pre-trained model's weights using the new task-specific data. This process can be computationally intensive, requiring significant processing resources and time. Furthermore, a recognized challenge associated with full fine-tuning is a phenomenon known as catastrophic forgetting. In this scenario, as the model adapts to the new task, its performance on its original, general tasks or on other out-of-distribution tasks may degrade significantly. This can also reduce the model's zero-shot classification and retrieval capabilities, which are valuable characteristics of the original pre-trained model.

### SUMMARY

One aspect of the disclosure provides a method that executes on data processing hardware that causes the data processing hardware to perform operations. The operations include obtaining a pre-trained neural network model having a plurality of layers, the plurality of layers having a corresponding plurality of pre-trained weight matrices. The operations include augmenting at least one layer of the plurality of layers with a plurality of parameter-efficient adaptation modules. Each parameter-efficient adaptation module of the plurality of parameter-efficient adaptation modules is configured to generate a respective weight update matrix based on a low-rank factorization and is associated with a respective learnable scoring parameter. The operations include fine-tuning the pre-trained neural network model on a target dataset to generate a fine-tuned model while the pre-trained weight matrices are maintained in a frozen state. The fine-tuning includes, for each of a plurality of training iterations, performing a forward pass, determining a total loss value, and updating parameters. During the forward pass, for each parameter-efficient adaptation module, an indicator function selectively applies the respective weight update matrix based on a comparison of the respective learnable scoring parameter to a predetermined threshold. The total loss value is determined based on a combination of a task-specific loss and a regularization term, where the regularization term is configured to induce sparsity by applying a penalty proportional to a norm of the respective learnable scoring parameters. The parameters of the plurality of parameter-efficient adaptation modules and the respective learnable scoring parameters are updated based on the total loss value. The operations also include providing the fine-tuned model, which has a sparse subset of activated parameter-efficient adaptation modules, for performing an inference task.

Implementations of the disclosure may include one or more of the following optional features. In some implementations, the parameter-efficient adaptation modules are Low-Rank Adaptation (LoRA) modules. The regularization term may be proportional to a sum of absolute values of the respective learnable scoring parameters. Optionally, the pre-trained neural network model is a transformer-based model selected from the group consisting of a vision model and a vision-language model. In some of these examples, the parameter-efficient adaptation modules are augmented to at least one of a query component, a key component, a value component, or a feed-forward network component within a transformer block of the pre-trained neural network model.

In some examples, the sparse subset of activated parameter-efficient adaptation modules includes fewer than twenty-five percent of the plurality of parameter-efficient adaptation modules augmented to the at least one layer. Fine-tuning the pre-trained neural network model may further include adjusting a hyperparameter that controls a magnitude of the penalty applied by the regularization term to control a trade-off between accuracy on the target dataset and performance on an out-of-distribution dataset. Performing the inference task using the fine-tuned model may require fewer floating-point operations per second (FLOPs) than performing the inference task using a second fine-tuned model in which the regularization term is omitted from the total loss value during fine-tuning.

In certain implementations related to vehicle systems, the target dataset includes sensor data captured from a vehicle, and the inference task involves processing real-time sensor data from the vehicle to provide an output to an advanced driver-assistance system (ADAS) of the vehicle. In such implementations, the target dataset may correspond to a first vehicle operational context. The operations may further include generating a second fine-tuned model by fine-tuning the pre-trained neural network model on a second target dataset corresponding to a second vehicle operational context, where the second fine-tuned model has a second sparse subset of activated parameter-efficient adaptation modules. The operations may also include selecting, based on a current operational context of a vehicle, one of the fine-tuned model or the second fine-tuned model to perform the inference task.

Another aspect of the disclosure provides a system. The system includes data processing hardware and memory hardware in communication with the data processing hardware. The memory hardware stores instructions that when executed on the data processing hardware cause the data processing hardware to perform operations. The operations include obtaining a pre-trained neural network model having a plurality of layers, the plurality of layers having a corresponding plurality of pre-trained weight matrices. The operations include augmenting at least one layer of the plurality of layers with a plurality of parameter-efficient adaptation modules. Each parameter-efficient adaptation module of the plurality of parameter-efficient adaptation modules is configured to generate a respective weight update matrix based on a low-rank factorization and is associated with a respective learnable scoring parameter. The operations include fine-tuning the pre-trained neural network model on a target dataset to generate a fine-tuned model while the pre-trained weight matrices are maintained in a frozen state. The fine-tuning includes, for each of a plurality of training iterations, performing a forward pass, determining a total loss value, and updating parameters. During the forward pass, for each parameter-efficient adaptation module, an indicator function selectively applies the respective weight update matrix based on a comparison of the respective learnable scoring parameter to a predetermined threshold. The total loss value is determined based on a combination of a task-specific loss and a regularization term, where the regularization term is configured to induce sparsity by applying a penalty proportional to a norm of the respective learnable scoring parameters. The parameters of the plurality of parameter-efficient adaptation modules and the respective learnable scoring parameters are updated based on the total loss value. The operations also include providing the fine-tuned model, which has a sparse subset of activated parameter-efficient adaptation modules, for performing an inference task.

Implementations of the disclosure may include one or more of the following optional features. In some implementations, the parameter-efficient adaptation modules are Low-Rank Adaptation (LoRA) modules. The regularization term may be proportional to a sum of absolute values of the respective learnable scoring parameters. Optionally, the pre-trained neural network model is a transformer-based model selected from the group consisting of a vision model and a vision-language model. In some of these examples, the parameter-efficient adaptation modules are augmented to at least one of a query component, a key component, a value component, or a feed-forward network component within a transformer block of the pre-trained neural network model.

In some examples, the sparse subset of activated parameter-efficient adaptation modules includes fewer than twenty-five percent of the plurality of parameter-efficient adaptation modules augmented to the at least one layer. Fine-tuning the pre-trained neural network model may further include adjusting a hyperparameter that controls a magnitude of the penalty applied by the regularization term to control a trade-off between accuracy on the target dataset and performance on an out-of-distribution dataset. Performing the inference task using the fine-tuned model may require fewer floating-point operations per second (FLOPs) than performing the inference task using a second fine-tuned model in which the regularization term is omitted from the total loss value during fine-tuning.

Another aspect of the disclosure provides computer-readable medium having instructions that, when executed by data processing hardware, causes the data processing hardware to perform operations. The operations include obtaining a pre-trained neural network model having a plurality of layers, the plurality of layers having a corresponding plurality of pre-trained weight matrices. The operations include augmenting at least one layer of the plurality of layers with a plurality of parameter-efficient adaptation modules. Each parameter-efficient adaptation module of the plurality of parameter-efficient adaptation modules is configured to generate a respective weight update matrix based on a low-rank factorization and is associated with a respective learnable scoring parameter. The operations include fine-tuning the pre-trained neural network model on a target dataset to generate a fine-tuned model while the pre-trained weight matrices are maintained in a frozen state. The fine-tuning includes, for each of a plurality of training iterations, performing a forward pass, determining a total loss value, and updating parameters. During the forward pass, for each parameter-efficient adaptation module, an indicator function selectively applies the respective weight update matrix based on a comparison of the respective learnable scoring parameter to a predetermined threshold. The total loss value is determined based on a combination of a task-specific loss and a regularization term, where the regularization term is configured to induce sparsity by applying a penalty proportional to a norm of the respective learnable scoring parameters. The parameters of the plurality of parameter-efficient adaptation modules and the respective learnable scoring parameters are updated based on the total loss value. The operations also include providing the fine-tuned model, which has a sparse subset of activated parameter-efficient adaptation modules, for performing an inference task.

### BRIEF DESCRIPTION OF THE DRAWINGS

The drawings described herein are for illustrative purposes only of selected configurations and are not intended to limit the scope of the present disclosure.

FIG. 1 is a schematic view of an example system for generating and deploying an adapted neural network model to a vehicle.

FIG. 2 is a functional block diagram illustrating the data flow through a neural network layer augmented with a selectively gated adaptation module.

FIG. 3 is a flowchart of an example arrangement of operations for a method of selectively adapting a pre-trained neural network model.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Large-scale foundation models, such as vision and vision-language models, are pre-trained on vast, general-purpose datasets. These models possess a broad understanding that is highly valuable for applications in advanced driver-assistance systems (ADAS) and autonomous driving. However, to ensure safety and reliability, these general models must be adapted, or fine-tuned, for specific operational design domains, such as unique road conditions in a new geographic region or the identification of novel classes of road hazards. A significant challenge in this adaptation process is the phenomenon of catastrophic forgetting, where the model's performance on its original, general tasks degrades as it learns the new, specialized task. This degradation may also compromise other valuable model properties, such as the zero-shot capabilities of vision-language models, which is their ability to perform inference on tasks for which they were not explicitly fine-tuned. For a vehicle, this could mean that fine-tuning a model to better recognize construction zones might inadvertently reduce its ability to accurately identify pedestrians or cyclists in other contexts.

Many fine-tuning approaches present a difficult trade-off. Fully fine-tuning a model by retraining all of its weights is computationally expensive and exacerbates catastrophic forgetting, compromising the model's general robustness. This approach is impractical for deployment across a large fleet of vehicles that may require frequent updates or adaptations for different environments. On the other hand, parameter-efficient fine-tuning (PEFT) methods, such as Low-Rank Adaptation (LoRA), reduce the computational burden by only training a small set of new parameters. However, these methods still suffer from knowledge degradation. To achieve high performance on a new, in-distribution task, such as identifying a specific type of delivery drone a vehicle may encounter, it is often beneficial to increase the complexity of the PEFT modules. In the context of LoRA, this is controlled by a parameter known as the ‘rank,’ which dictates the size and expressive power of the low-rank adaptation matrices. Using a higher rank may improve accuracy on the new task but often leads to a more severe loss of pre-trained knowledge, creating a persistent conflict between specialization and generalization.

The systems and methods disclosed herein address these and other issues by providing a technical solution for selectively and efficiently adapting a pre-trained neural network model. In some examples, a method involves obtaining a pre-trained model and augmenting one or more of its layers with a plurality of parameter-efficient adaptation modules. Each of these modules, which is configured to generate a weight update based on a low-rank factorization, is associated with a respective learnable scoring parameter. The system fine-tunes the model on a target dataset while keeping the original pre-trained weight matrices frozen. During this fine-tuning process, an indicator function selectively applies the weight update from each module based on a comparison of the module's learned scoring parameter to a threshold. A total loss function, which combines a task-specific loss with a sparsity-inducing regularization term, guides the updating of both the adaptation module parameters and the scoring parameters, thereby teaching the system which modules are most effective for the given task.

This approach of applying a selective gating mechanism to parallel adaptation modules is distinct from any model pruning techniques that may also use a form of gating or indicator function. Such techniques may apply such a function directly to the primary weight matrices of a model with the goal of pruning elements of the original, pre-trained weights themselves. In contrast, the systems and methods disclosed herein may apply the indicator function specifically and exclusively to the parameter-efficient adaptation modules. The original pre-trained weight matrices remain frozen and are not subjected to the pruning mechanism. The selection, therefore, can be focused on which targeted, low-rank modifications to activate. This makes the adaptation more parameter-efficient and surgical, preserving the integrity of the foundational knowledge embedded in the pre-trained model.

This process results in a fine-tuned model that utilizes only a sparse subset of the available adaptation modules. For example, when adapting a vehicle's perception model to function in snowy conditions, the system may learn that only a small fraction of adaptation modules (e.g., those in layers responsible for texture and color analysis_ need to be activated. The regularization term penalizes the use of non-essential modules, effectively pruning them from the computation path. This allows the model to learn the new, specific features of a snowy environment while making minimal changes to its core, pre-trained knowledge base. The final fine-tuned model can then be provided to perform an inference task, such as real-time object detection for a vehicle's ADAS.

The disclosed implementations provide several technical benefits and improvements to the functionality of the underlying computing systems. By generating a fine-tuned model with a sparse set of active adaptation modules, the method reduces the number of floating-point operations per second (FLOPs) required during inference. This computational efficiency is a direct improvement to the computer's performance, enabling faster real-time decision-making on the resource-constrained processing hardware commonly found in vehicles. Furthermore, this approach enhances memory management and model deployment. A vehicle's onboard system can store a single, frozen base model and several distinct, highly compact sets of sparse adaptation parameters for different operational contexts, such as “night driving,” “heavy rain,” or “urban canyon.” The system can then dynamically load only the necessary lightweight modules, which improves memory usage and enables more flexible and efficient model management across a vehicle fleet.

These technical improvements result in advantages for vehicle safety and scalability. The mitigation of catastrophic forgetting ensures that a vehicle's perception system maintains its robust, general knowledge while also excelling in specialized conditions, leading to more reliable and safer ADAS performance across diverse driving environments. For a vehicle manufacturer, this enables the rapid and cost-effective development of specialized models for different vehicle lines or geographic markets without requiring full, resource-intensive retraining cycles. This accelerates the deployment of new safety features and system updates, improving the adaptability and performance of the entire vehicle fleet.

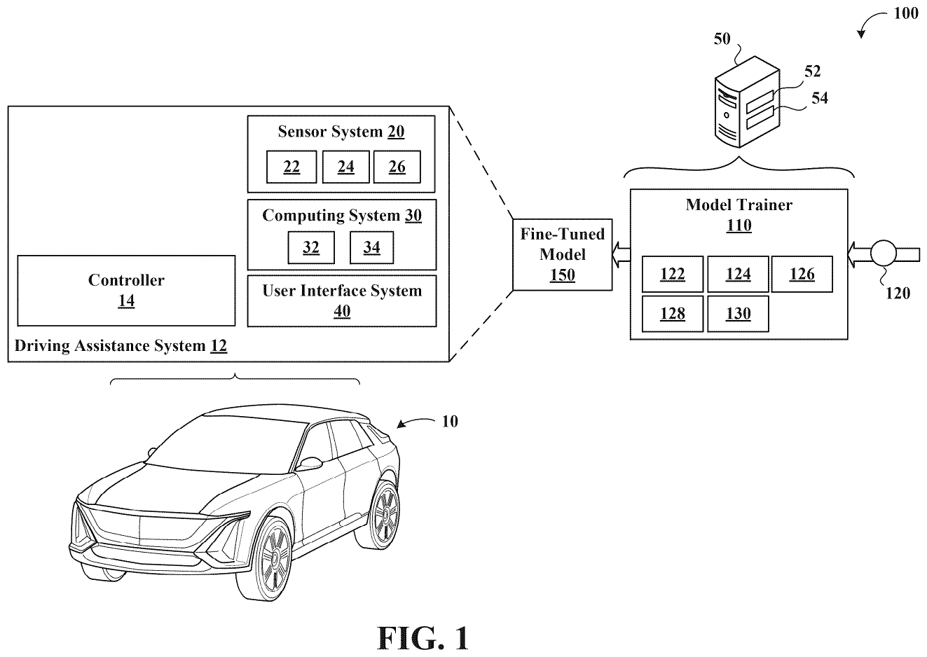

Referring to FIG. 1, a system 100 for adapting a neural network model is shown. The system 100 includes a remote computing system 50 and a vehicle 10. The remote computing system 50 may be a single computer, multiple computers, or a distributed system (e.g., a cloud environment) having scalable / elastic resources including computing resources 52 (e.g., data processing hardware) and/or storage resources 54 (e.g., memory hardware). The memory 54 stores instructions that, when executed by the data processing hardware 52, configure the remote computing system 50 to operate as a model trainer 110. The model trainer 110 is configured to generate a fine-tuned model 150 from a pre-trained neural network model 120. The fine-tuned model 150 may be subsequently deployed to the vehicle 10 for use by an onboard driving assistance system 12. While described as a remote system, in some implementations, the functionality of the model trainer 110 may be performed in whole or in part on computing resources within the vehicle 10.

The model trainer 110 is configured to perform operations to generate the fine-tuned model 150. The model trainer 110 obtains the pre-trained neural network model 120, which may be a large-scale foundation model, such as a transformer-based vision model or vision-language model. The pre-trained model 120 includes a plurality of layers having a corresponding plurality of pre-trained weight matrices. The model trainer 110 augments at least one layer of the pre-trained model 120 with a plurality of parameter-efficient adaptation modules 122. In some examples, these are Low-Rank Adaptation (LoRA) modules. Each parameter-efficient adaptation module 122 is configured to generate a respective weight update matrix based on a low-rank factorization and is associated with a respective learnable scoring parameter 124.

The selective activation approach is broadly applicable and is not limited to a single type of parameter-efficient adaptation module. While Low-Rank Adaptation (LoRA) is described as an exemplary implementation, the indicator function 128 and its associated learnable scoring parameter 124 may be applied to other PEFT methods. For example, the gating mechanism may be integrated with LoRA variants, such as Weight-Decomposed Low-Rank Adaptation (DoRA), or other techniques that introduce parallel, trainable parameters. In any such implementation, the indicator function 128 operates on the output of the respective adaptation module to selectively apply its contribution, thereby providing the benefits of sparse activation regardless of the specific underlying PEFT architecture.

In implementations where the pre-trained neural network model 120 is a transformer-based model, each transformer layer, or block, typically includes a self-attention mechanism and a feed-forward network component, which is often a multi-layer perceptron (MLP). The self-attention mechanism itself may be further deconstructed into a query component, a key component, and a value component that operate on input data. The operation of augmenting the model, as performed by the model trainer 110, may involve adding the parameter-efficient adaptation modules 122 to one or more of these specific components. For example, separate adaptation modules 122 may be augmented in parallel with the weight matrices corresponding to the query, key, value, and feed-forward network components within one or more transformer blocks. The selective activation process may then learn that activating modules in certain components is more effective for a given task. For instance, in some examples involving a vision-language model, the system may learn to activate modules primarily in the feed-forward network components of the final layers of the vision transformer, as these components contain a larger number of parameters and may be more influential in modifying the model's behavior for a specialized visual task.

The model trainer 110 fine-tunes the augmented model on a target dataset 126 to generate the fine-tuned model 150. During this process, the original pre-trained weight matrices of the model 120 are maintained in a frozen state. The fine-tuning is an iterative process. For each training iteration, the model trainer 110 performs a forward pass. During the forward pass, for each parameter-efficient adaptation module 122, an indicator function 128 selectively applies the respective weight update matrix. This selection is based on a comparison of the respective learnable scoring parameter 124 to a predetermined threshold 130. The model trainer 110 determines a total loss value based on a combination of a task-specific loss and a regularization term. The regularization term is configured to induce sparsity by applying a penalty proportional to a norm of the learnable scoring parameters, for example, a penalty proportional to a sum of the absolute values of the scoring parameters. Finally, the model trainer 110 updates the parameters of the adaptation modules 122 and the respective learnable scoring parameters 124 based on the determined total loss value.

The process of updating the learnable scoring parameters 124 in response to the total loss value addresses a technical challenge presented by the indicator function 128. Because the indicator function 128 is a discrete step function, it is non-differentiable, which normally prevents the flow of gradients during backpropagation. To overcome this, the model trainer 110 may employ a Straight-Through Estimator (STE) during the training process. During the forward pass, the indicator function 128 operates as described, outputting a binary value of zero or one. During the backward pass, the STE approximates the derivative of the indicator function, for example, by treating its derivative as one. This allows the gradient from the total loss to pass “straight through” the indicator function 128 to the corresponding learnable scoring parameter 124. This technique enables the end-to-end, gradient-based optimization of the scoring parameters, allowing the system to effectively learn which parameter-efficient adaptation modules 122 to activate for the target task.

While the regularization term may be proportional to a sum of absolute values of the scoring parameters (an [symbol] -norm), which is effective at inducing sparsity, other regularization functions may also be used. In some implementations, the regularization term may be proportional to a sum of the squared values of the respective learnable scoring parameters (an ( [symbol] -norm). This form of regularization encourages smaller scoring parameter values overall but may be less effective at driving parameter values to exactly zero compared to the [symbol] -norm. In other implementations, a hinge loss may be used. For example, the penalty may be proportional to a sum based on the maximum of zero and the difference between each scoring parameter and the predetermined threshold. This approach penalizes a scoring parameter only after it has exceeded the activation threshold, which may result in a less aggressive pruning of adaptation modules. The selection of a particular regularization function provides an additional mechanism for controlling the final sparsity and performance characteristics of the fine-tuned model 150.

The fine-tuning process performed by the model trainer 110 may further include a mechanism for controlling the balance between specialization and generalization. For example, the magnitude of the penalty applied by the regularization term is controlled by a configurable hyperparameter. By adjusting this hyperparameter, it is possible to control a trade-off between the model's accuracy on the target dataset 126 and its performance on an out-of-distribution dataset, which reflects the retention of pre-trained knowledge. For example, selecting a lower value for the hyperparameter applies a weaker penalty, which may result in more activated parameter-efficient adaptation modules 122 and potentially higher accuracy on the target dataset. Conversely, adjusting the hyperparameter to a higher value imposes a stronger penalty, which encourages greater sparsity by deactivating more modules. This action enhances knowledge retention and improves performance on out-of-distribution tasks, thereby mitigating catastrophic forgetting. This adjustability allows for the generation of a fine-tuned model 150 that is optimized for a specific balance of performance characteristics as required by a particular application.

After the fine-tuning process is complete, the model trainer 110 provides the fine-tuned model 150 for performing an inference task. The resulting fine-tuned model 150 includes a sparse subset of activated parameter-efficient adaptation modules 122. For instance, the sparse subset may include fewer than twenty-five percent of the total number of adaptation modules 122 that were initially augmented to the pre-trained model 120. This sparsity provides a technical benefit by reducing the computational resources, such as the number of floating-point operations per second (FLOPs), required to execute the fine-tuned model 150 during inference compared to a model fine-tuned without the sparsity-inducing regularization.

The fine-tuned model 150 may be deployed to a mobile platform, such as the vehicle 10 shown, for execution by an onboard controller 14. While FIG. 1 depicts a passenger vehicle, the term “vehicle” is used broadly herein to encompass any mobile platform that benefits from an adapted perception or control model. Examples include, but are not limited to, autonomous mobile robots (AMRs) operating in warehouses or manufacturing facilities, agricultural machinery performing automated tasks in a field, construction equipment, and unmanned aerial vehicles (UAVs) or delivery drones. The disclosed methods also extend beyond perception and control tasks. For example, in an image generation application, the fine-tuned model 150 may be a generative model. The selective adaptation process allows the model to be fine-tuned to generate a specific object or artistic style, while the sparse activation preserves the integrity of the base model, preventing degradation of its ability to generate a wide variety of other, general images. The controller 14 is part of an onboard control system, such as the driving assistance system 12 shown, which also includes an onboard computing system 30 with its own data processing hardware 32 and memory 34, a sensor system 20, a user interface system 40, and a network interface (not shown). The controller 14 uses the fine-tuned model 150 to perform an inference task, which involves processing real-time sensor data from the sensor system 20. The sensor system 20 may include various sensors such as one or more cameras 22, radar sensors 24, or lidar sensors 26. The target dataset used by the model trainer 110 may be composed of sensor data previously captured by such a sensor system 20.

The output of the inference task is provided to one or more functions of the driving assistance system 12, such as an adaptive cruise control system or an automated emergency braking system. In some implementations, the model trainer 110 may be used to generate multiple fine-tuned models 150. For example, a first fine-tuned model may be generated using a target dataset corresponding to a first vehicle operational context, such as daytime driving, and a second fine-tuned model may be generated for a second context, such as nighttime driving. The controller 14 may be configured to select one of the fine-tuned models to perform the inference task based on the current operational context of the vehicle 10, which may be determined from the sensor system 20 or other vehicle data. This allows for highly specialized, yet computationally efficient, models to be deployed for a wide range of driving scenarios.

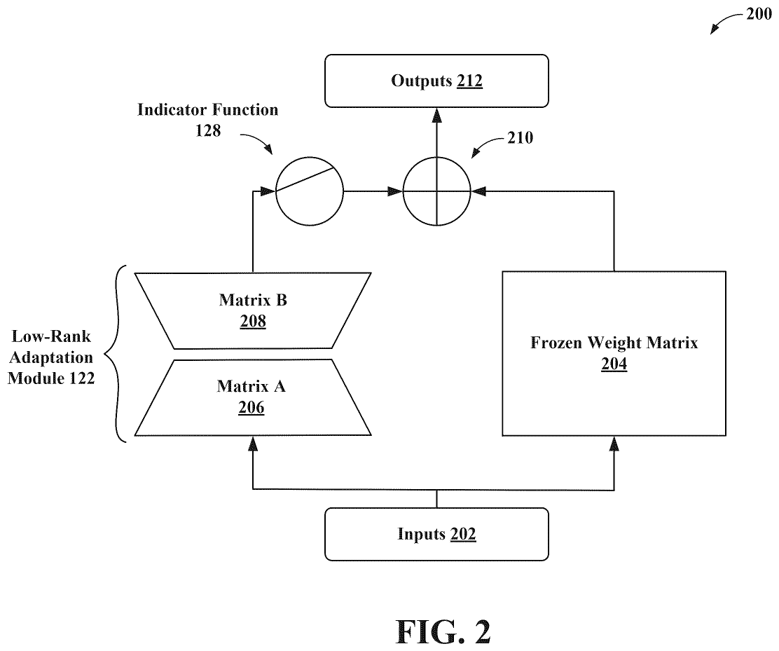

FIG. 2 illustrates a functional block diagram of an augmented neural network layer architecture 200, which may be implemented within the fine-tuned model 150 described in reference to FIG. 1. The architecture 200 depicts the data flow for a single layer that has been augmented for selective, parameter-efficient fine-tuning. This architecture enables the targeted adaptation of a pre-trained model while preserving its foundational knowledge.

The architecture 200 processes input data 202, which may be the output from a preceding layer of the neural network. The input data 202 is fed into two parallel processing paths. The first path involves a frozen weight matrix 204, which represents the original, pre-trained weights of the layer from the pre-trained model 120. As these weights are frozen, they are not updated during the fine-tuning process and thus represent the stable, pre-existing knowledge of the model. The second path involves a parameter-efficient adaptation module 122, such as a LoRA module. This module 122 is configured to generate a weight update matrix based on a low-rank factorization. In the example shown, the module 122 includes a first low-rank matrix 206 (Matrix A) and a second low-rank matrix 208 (Matrix B). The input data 202 is processed through these trainable matrices to produce an adaptation signal or weight update.

The output of the parameter-efficient adaptation module 122 is gated by an indicator function 128. As described previously, the behavior of the indicator function 128 is determined by a corresponding learnable scoring parameter 124 and a predetermined threshold 130, which are learned during the fine-tuning process performed by the model trainer 110. The indicator function 128 selectively applies the weight update matrix generated by the adaptation module 122. In effect, the indicator function 128 may act as a learned switch. If the scoring parameter 124 indicates that the adaptation module 122 is significant for the target task, the indicator function 128 allows the adaptation signal to pass through. Conversely, if the module 122 is deemed non-essential for the task, the indicator function 128 deactivates the module by blocking its output, for example, by multiplying it by zero.

A combiner 210, such as an adder, receives outputs from both parallel paths. It receives the primary output from the frozen weight matrix 204 and the gated output from the indicator function 128. The combiner 210 sums these two signals to produce the final output data 212 for the layer. When the indicator function 128 deactivates the adaptation module 122, the output of the layer is solely determined by the frozen weight matrix 204, thus perfectly preserving the model's original behavior for that specific module. When the module 122 is activated, the layer's output is a combination of the original behavior and the learned, task-specific adaptation. This architecture 200 directly enables the generation of a fine-tuned model 150 with a sparse subset of activated modules, thereby mitigating catastrophic forgetting and improving computational efficiency for inference tasks.

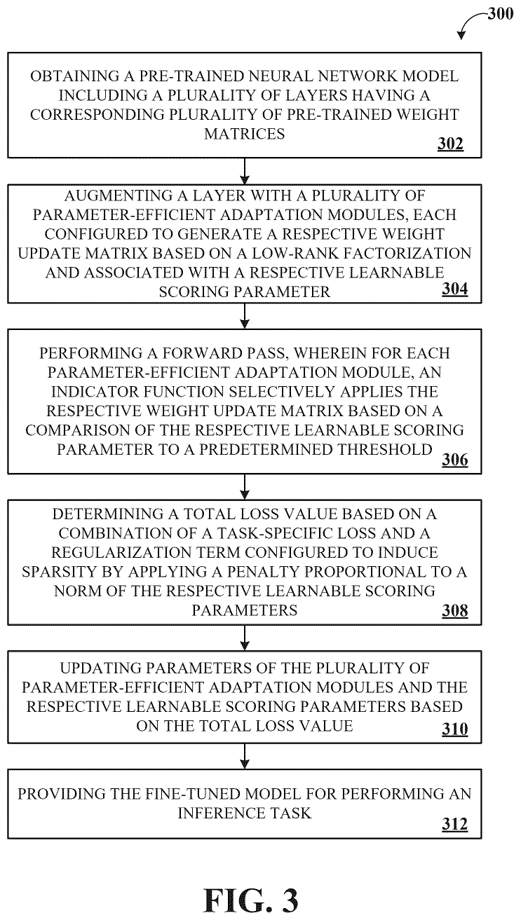

FIG. 3 is a flowchart of an exemplary arrangement of operations for a method 300 for selectively adapting a neural network model. The method 300 may be performed by data processing hardware 52, such as the model trainer 110 described in reference to FIG. 1. The method 300 begins at operation 302, which includes obtaining a pre-trained neural network model 120. The pre-trained model 120 includes a plurality of layers having a corresponding plurality of pre-trained weight matrices 204. For example, the model trainer 110 obtains a general-purpose foundation model that has been trained on a large, diverse dataset. At operation 304, the method 300 includes augmenting at least one layer of the model with a plurality of parameter-efficient adaptation modules 122. Each module 122 is configured to generate a respective weight update matrix based on a low-rank factorization and is associated with a respective learnable scoring parameter 124. This prepares the model for efficient fine-tuning without altering its original structure.

The method 300 then enters an iterative fine-tuning loop. At operation 306, the method 300 includes performing a forward pass through the augmented model. During this pass, for each parameter-efficient adaptation module 122, an indicator function 128 selectively applies the respective weight update matrix. This selective application is based on a comparison of the respective learnable scoring parameter 124 to a predetermined threshold 130. At operation 308, the method 300 includes determining a total loss value. This value is based on a combination of a task-specific loss, which measures performance on the target dataset 126, and a regularization term. The regularization term is configured to induce sparsity by applying a penalty proportional to a norm of the respective learnable scoring parameters 124.

At operation 310, the method 300 includes updating parameters of the plurality of parameter-efficient adaptation modules 122 and the respective learnable scoring parameters 124 based on the total loss value. Through this update step, the model trainer 110 simultaneously learns how to perform the new task and which adaptation modules 122 are most effective for that task. At operation 312, after the iterative fine-tuning is complete, the method 300 includes providing the fine-tuned model 150 for performing an inference task. The resulting fine-tuned model 150 is a specialized model that includes a sparse subset of activated adaptation modules 122.

The arrangement of operations in method 300 provides technical improvements to the functionality of the computer systems involved in both training and inference. By combining the sparsity-inducing regularization of operation 308 with the selective application of updates in operation 306, the method 300 solves the technical problem of the inherent trade-off between task-specific performance and general knowledge retention. This process changes how a model is adapted. Instead of making broad, disruptive changes, the method 300 enables the system to learn minimal, targeted modifications. This directly improves the functioning of the computing hardware 32 during inference by producing a fine-tuned model 150 that requires fewer floating-point operations (FLOPs) and less memory bandwidth, as most adaptation modules 122 are deactivated. This efficiency gain is critical for real-time performance on the resource-constrained computing systems 30 found in vehicles and other mobile platforms.

Furthermore, the method 300 offers a technical benefit by creating a more scalable and manageable model deployment pipeline, which is an improvement to the overall technology ecosystem from the remote computing system 50 to the vehicle 10. The process of generating a fine-tuned model 150 with a sparse subset of modules addresses the technical challenge of deploying and updating models across a large fleet of vehicles that may operate in diverse environments. Instead of transmitting and storing numerous large, monolithic models, the system 100 can store a single, frozen base model 120 on the vehicle 10 and only transmit and store multiple, highly compact sets of sparse adaptation parameters. For example, a vehicle can maintain a small “profile” for “city driving” and another for “highway driving,” each containing only the parameters for the few activated modules. This improves the memory 34 efficiency on the vehicle's onboard system and significantly reduces the network bandwidth required for over-the-air updates, making the entire adaptation and deployment lifecycle more efficient and scalable.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executing on data processing hardware that causes the data processing hardware to perform operations comprising:
obtaining a pre-trained neural network model comprising a plurality of layers, the plurality of layers having a corresponding plurality of pre-trained weight matrices;
augmenting at least one layer of the plurality of layers with a plurality of parameter-efficient adaptation modules, each parameter-efficient adaptation module of the plurality of parameter-efficient adaptation modules configured to generate a respective weight update matrix based on a low-rank factorization and associated with a respective learnable scoring parameter;
fine-tuning the pre-trained neural network model on a target dataset to generate a fine-tuned model while the pre-trained weight matrices are maintained in a froze state, the fine-tuning comprising, for each of a plurality of training iterations:
performing a forward pass, wherein for each parameter-efficient adaptation module, an indicator function selectively applies the respective weight update matrix based on a comparison of the respective learnable scoring parameter to a predetermined threshold;
determining a total loss value based on a combination of a task-specific loss and a regularization term, the regularization term configured to induce sparsity by applying a penalty proportional to a norm of the respective learnable scoring parameters; and
updating parameters of the plurality of parameter-efficient adaptation modules and the respective learnable scoring parameters based on the total loss value; and
providing the fine-tuned model, comprising a sparse subset of activated parameter-efficient adaptation modules, for performing an inference task.

2. The method of claim 1, wherein the parameter-efficient adaptation modules are Low-Rank Adaptation (LoRA) modules.

3. The method of claim 1, wherein the regularization term is proportional to a sum of absolute values of the respective learnable scoring parameters.

4. The method of claim 1, wherein the pre-trained neural network model is a transformer-based model selected from the group consisting of a vision model and a vision-language model.

5. The method of claim 4, wherein the parameter-efficient adaptation modules are augmented to at least one of a query component, a key component, a value component, or a feed-forward network component within a transformer block of the pre-trained neural network model.

6. The method of claim 1, wherein the sparse subset of activated parameter-efficient adaptation modules comprises fewer than twenty-five percent of the plurality of parameter-efficient adaptation modules augmented to the at least one layer.

7. The method of claim 1, wherein fine-tuning the pre-trained neural network model further comprises adjusting a hyperparameter that controls a magnitude of the penalty applied by the regularization term to control a trade-off between accuracy on the target dataset and performance on an out-of-distribution dataset.

8. The method of claim 1, wherein:
the target dataset corresponds to a first vehicle operational context; and
the operations further comprise:
generating a second fine-tuned model by fine-tuning the pre-trained neural network model on a second target dataset corresponding to a second vehicle operational context, the second fine-tuned model comprising a second sparse subset of activated parameter-efficient adaptation modules; and
selecting, based on a current operational context of a vehicle, one of the fine-tuned model or the second fine-tuned model to perform the inference task.

9. The method of claim 1, wherein performing the inference task using the fine-tuned model requires fewer floating-point operations per second (FLOPs) than performing the inference task using a second fine-tuned model in which the regularization term is omitted from the total loss value during fine-tuning.

10. The method of claim 1, wherein the target dataset comprises sensor data captured from a vehicle, and wherein the inference task comprises processing real-time sensor data from the vehicle to provide an output to an advanced driver-assistance system (ADAS) of the vehicle.

11. A system comprising:
data processing hardware; and
memory hardware in communication with the data processing hardware, the memory hardware storing instructions that when executed on the data processing hardware cause the data processing hardware to perform operations comprising:
obtaining a pre-trained neural network model comprising a plurality of layers, the plurality of layers having a corresponding plurality of pre-trained weight matrices;
augmenting at least one layer of the plurality of layers with a plurality of parameter-efficient adaptation modules, each parameter-efficient adaptation module of the plurality of parameter-efficient adaptation modules configured to generate a respective weight update matrix based on a low-rank factorization and associated with a respective learnable scoring parameter;
fine-tuning the pre-trained neural network model on a target dataset to generate a fine-tuned model while the pre-trained weight matrices are maintained in a froze state, the fine-tuning comprising, for each of a plurality of training iterations:
performing a forward pass, wherein for each parameter-efficient adaptation module, an indicator function selectively applies the respective weight update matrix based on a comparison of the respective learnable scoring parameter to a predetermined threshold;
determining a total loss value based on a combination of a task-specific loss and a regularization term, the regularization term configured to induce sparsity by applying a penalty proportional to a norm of the respective learnable scoring parameters; and
updating parameters of the plurality of parameter-efficient adaptation modules and the respective learnable scoring parameters based on the total loss value; and
providing the fine-tuned model, comprising a sparse subset of activated parameter-efficient adaptation modules, for performing an inference task.

12. The system of claim 11, wherein the parameter-efficient adaptation modules are Low-Rank Adaptation (LoRA) modules.

13. The system of claim 11, wherein the regularization term is proportional to a sum of absolute values of the respective learnable scoring parameters.

14. The system of claim 11, wherein the pre-trained neural network model is a transformer-based model selected from the group consisting of a vision model and a vision-language model.

15. The system of claim 14, wherein the parameter-efficient adaptation modules are augmented to at least one of a query component, a key component, a value component, or a feed-forward network component within a transformer block of the pre-trained neural network model.

16. The system of claim 11, wherein the sparse subset of activated parameter-efficient adaptation modules comprises fewer than twenty-five percent of the plurality of parameter-efficient adaptation modules augmented to the at least one layer.

17. The system of claim 11, wherein fine-tuning the pre-trained neural network model further comprises adjusting a hyperparameter that controls a magnitude of the penalty applied by the regularization term to control a trade-off between accuracy on the target dataset and performance on an out-of-distribution dataset.

18. The system of claim 11, wherein:
the target dataset corresponds to a first vehicle operational context; and
the operations further comprise:
generating a second fine-tuned model by fine-tuning the pre-trained neural network model on a second target dataset corresponding to a second vehicle operational context, the second fine-tuned model comprising a second sparse subset of activated parameter-efficient adaptation modules; and
selecting, based on a current operational context of a vehicle, one of the fine-tuned model or the second fine-tuned model to perform the inference task.

19. The system of claim 11, wherein performing the inference task using the fine-tuned model requires fewer floating-point operations per second (FLOPs) than performing the inference task using a second fine-tuned model in which the regularization term is omitted from the total loss value during fine-tuning.

20. A computer-readable medium having instructions that, when executed by data processing hardware, causes the data processing hardware to perform operations comprising:
obtaining a pre-trained neural network model comprising a plurality of layers, the plurality of layers having a corresponding plurality of pre-trained weight matrices;
augmenting at least one layer of the plurality of layers with a plurality of parameter-efficient adaptation modules, each parameter-efficient adaptation module of the plurality of parameter-efficient adaptation modules configured to generate a respective weight update matrix based on a low-rank factorization and associated with a respective learnable scoring parameter;
fine-tuning the pre-trained neural network model on a target dataset to generate a fine-tuned model while the pre-trained weight matrices are maintained in a froze state, the fine-tuning comprising, for each of a plurality of training iterations:
performing a forward pass, wherein for each parameter-efficient adaptation module, an indicator function selectively applies the respective weight update matrix based on a comparison of the respective learnable scoring parameter to a predetermined threshold;
determining a total loss value based on a combination of a task-specific loss and a regularization term, the regularization term configured to induce sparsity by applying a penalty proportional to a norm of the respective learnable scoring parameters; and
updating parameters of the plurality of parameter-efficient adaptation modules and the respective learnable scoring parameters based on the total loss value; and
providing the fine-tuned model, comprising a sparse subset of activated parameter-efficient adaptation modules, for performing an inference task.
